(19) United States
(12) Patent Application Publication
(10) Pub. No.: US 2014/0375698 A1
(43) Pub. Date: Dec. 25, 2014

(54) METHOD FOR ADJUSTING DISPLAY UNIT AND ELECTRONIC DEVICE

(71) Applicant: Lenovo (Beijing) Co., Ltd., Beijing (CN)

(72) Inventors: Zhenhua Zhang, Beijing (CN); Ke Shang, Beijing (CN)

(73) Assignee: Lenovo (Beijing) Co., Ltd., Beijing (CN)

(21) Appl. No.: 14/228,588

(22) Filed: Mar. 28, 2014

(30) Foreign Application Priority Data
Jun. 19, 2013 (CN) 201310244085.3

(51) Int. Cl. G09G 3/20

(52) U.S. Cl. CPC G09G 3/2003
USPC 345/690

(57) ABSTRACT

The embodiments of the disclosure provide a method for adjusting a display unit. The method is applied to an electronic device having the display unit, and in a case where a current viewing angle at which a user views the display unit is a first angle, a current brightness of the display unit is a first brightness. The method includes: detecting whether the current viewing angle is adjusted from the first angle to a second angle different from the first angle, and obtaining a first detection result; determining a brightness corresponding to the second angle as a second brightness different from the first brightness based on a viewing angle-to-brightness correspondence in a case where it is indicated by the first detection result that the current viewing angle is adjusted to the second angle; and adjusting the current brightness from the first brightness to the second brightness.

### CROSS REFERENCE TO RELATED APPLICATION

This application claims the benefit of priority to Chinese Patent Application No. 201310244085.3, entitled “METHOD FOR ADJUSTING DISPLAY UNIT AND ELECTRONIC DEVICE”, filed on Jun. 19, 2013 with State Intellectual Property Office of PRC, which is incorporated herein by reference in its entirety.

### FIELD

The disclosure relates to the field of electronic display technology, and particularly to a method for adjusting a display unit and an electronic device.

### BACKGROUND

Along with development of sciences and technologies, electronics also have gained rapid development. There are increasing types of electronic products, and people also have enjoyed various conveniences as a result of the development of sciences and technologies. Now people can enjoy a comfortable life brought by the development of sciences and technologies through various types of electronic devices. For example, all-in-one PC, tablet computer and so on emerge in people's field of vision. The existing tablet includes the portable tablet with small size and the desktop tablet with large size. Different display effects can be achieved for a user by placing display units having different forms. For example, a display screen of the all-in-one PC is placed vertically, and therefore the user can intuitively obtain the maximum brightness of the display unit when viewing the display screen of the all-in-one PC in a direction perpendicular to the screen. For another example, a display screen of the big tablet is laid down and therefore the user does not view the laid down display screen in a direction perpendicular to the screen. Of course, in a case where the small tablet is used by the user, the display screen of the small tablet is at a certain angle with the user's line of sight since the user holds the small tablet in different ways.

It is found by the inventors that there is at least the following technical problem in the technology described above.

A technical problem in the prior art is that the brightness of the display unit of the electronic device can not vary with the viewing angle of the user.

Due to the technical problem described above, the user may feel that the brightness of the display unit is not enough while viewing the display unit from an oblique viewing angle, which further exerts an influence on the visual effect. Accordingly, there is also a problem in the display unit of the electronic device in the prior art that user experience is poor.

### SUMMARY

The embodiments of the disclosure provide a method for adjusting a display unit and an electronic device, to solve the technical problem in the prior art that a brightness of a display unit of an electronic device can not vary with a viewing angle of a user, and further realize a technical effect that a display brightness can be adjusted automatically by the electronic device when the viewing angle is changed.

The embodiments of the disclosure provide a method for adjusting a display unit. The method is applied to an electronic device having the display unit, and in a case where a current viewing angle at which a user views the display unit is a first angle, a current brightness of the display unit is a first brightness. The method includes: detecting whether the current viewing angle is adjusted from the first angle to a second angle different from the first angle, and obtaining a first detection result; determining a brightness corresponding to the second angle as a second brightness different from the first brightness based on a viewing angle-to-brightness correspondence in a case where it is indicated by the first detection result that the current viewing angle is adjusted to the second angle; and adjusting the current brightness from the first brightness to the second brightness.

Preferably, before detecting whether the current viewing angle is adjusted from the first angle to a second angle different from the first angle, the method further includes: detecting first placement state information of the display unit; obtaining first relative position information for the user and the display unit based on the first placement state information; and obtaining the current viewing angle at which the user views the display unit based on the first relative position information.

Preferably, detecting first placement state information of the display unit includes: detecting the first placement state information of the display unit by a gravity sensing apparatus in the electronic device.

Preferably, obtaining first relative position information for the user and the display unit based on the first placement state information includes: capturing first position information of the user by an image capturing apparatus provided above the display unit; and obtaining first relative position information for the user and the display unit based on the first placement state information and the first position information.

Preferably, obtaining the current viewing angle at which the user views the display unit based on the first relative position information includes: detecting whether the first relative position information is in conformity with a first preset relative position, and obtaining a second detection result; and determining a first viewing angle corresponding to the first preset relative position as the current viewing angle based on a preset relative position-to-viewing angle correspondence in a case where it is indicated by the second detection result that the first relative position information is in conformity with the first preset relative position.

Preferably, determining a brightness corresponding to the second angle as a second brightness different from the first brightness based on a viewing angle-to-brightness correspondence in a case where it is indicated by the first detection result that the current viewing angle is adjusted to the second angle includes: deciding, in a case where it is indicated by the first detection result that the current viewing angle is adjusted to the second angle, whether the second angle is greater than the first angle, and obtaining a first decision result; determining the brightness corresponding to the second angle as the second brightness greater than the first brightness based on the viewing angle-to-brightness correspondence in a case where it is indicated by the first decision result that the second angle is greater than the first angle; or determining the brightness corresponding to the second angle as the second brightness smaller than the first brightness based on a viewing angle-to-brightness correspondence in a case where it is indicated by the first decision result that the second angle is smaller than the first angle.

Preferably, adjusting the current brightness from the first brightness to the second brightness includes: adjusting the current brightness from the first brightness to the second brightness greater than the first brightness in a case where the brightness corresponding to the second angle is the second brightness greater than the first brightness; or adjusting the current brightness from the first brightness to the second brightness smaller than the first brightness in a case where the brightness corresponding to the second angle is the second brightness smaller than the first brightness.

In another aspect, the embodiments of the disclosure provide an electronic device including a display unit. The electronic device further includes: a first detection module configured to detect whether a current viewing angle is adjusted from a first angle to a second angle different from the first angle, and obtain a first detection result; a first determination module configured to determine a brightness corresponding to the second angle as a second brightness different from the first brightness based on a viewing angle-to-brightness correspondence in a case where it is indicated by the first detection result that the current viewing angle is adjusted to the second angle; and a first adjustment module configured to adjust the current brightness from the first brightness to the second brightness.

Preferably, the electronic device further includes: a second detection module configured to detect first placement state information of the display unit; a first obtaining module configured to obtain first relative position information for the user and the display unit based on the first placement state information; and a second obtaining module configured to obtain the current viewing angle at which the user views the display unit based on the first relative position information.

Preferably, the second detection module is a gravity sensing apparatus.

Preferably, the first obtaining module includes: a capturing unit configured to capture first position information of the user by an image capturing apparatus provided above the display unit; and a first obtaining subunit configured to obtain first relative position information for the user and the display unit based on the first placement state information and the first position information.

Preferably, the second obtaining module includes: a first detection subunit configured to detect whether the first relative position information is in conformity with a first preset relative position, and obtain a second detection result; and a first determination subunit configured to determine a first viewing angle corresponding to the first preset relative position as the current viewing angle based on a preset relative position-to-viewing angle correspondence in a case where it is indicated by the second detection result that the first relative position information is in conformity with the first preset relative position.

Preferably, the first determination module includes: a first decision unit configured to decide, in a case where it is indicated by the first detection result that the current viewing angle is adjusted to the second angle, whether the second angle is greater than the first angle and obtain a first decision result; a second determination subunit configured to determine the brightness corresponding to the second angle as the second brightness greater than the first brightness based on the viewing angle-to-brightness correspondence in a case where it is indicated by the first decision result that the second angle is greater than the first angle; a third determination subunit configured to determine the brightness corresponding to the second angle as the second brightness smaller than the first brightness based on the viewing angle-to-brightness correspondence in a case where it is indicated by the first decision result that the second angle is smaller than the first angle.

Preferably, the first adjustment module includes: a first adjustment subunit configured to adjust the current brightness from the first brightness to the second brightness greater than the first brightness in a case where the brightness corresponding to the second angle is the second brightness greater than the first brightness; and a second adjustment subunit configured to adjust the current brightness from the first brightness to the second brightness smaller than the first brightness in a case where the brightness corresponding to the second angle is the second brightness smaller than the first brightness.

There are at least the following technical effects or advantages in one or more technical solutions provided by the embodiments of the disclosure.

1. A change in a viewing angle at which the user views the display unit is obtained automatically by the electronic device, and a brightness corresponding to the current viewing angle is obtained according to a viewing angle-to-brightness correspondence, hence the brightness is adjusted to achieve an optimum display brightness, which effectively solves the technical problem in the prior art that the brightness of the display unit of the electronic device can not vary with a viewing angle of a user, and further realizes a technical effect that a display brightness can be adjusted automatically by the electronic device in a case where the viewing angle is changed.

2. The first placement state information of the display unit is detected by the gravity sensing apparatus, and the first position information of the user is captured by the image capturing apparatus, and then the first relative position information for the user and the display unit is then obtained based on the obtained first placement state information and the first position information, which solves the technical problems in the prior art that the information of a relative position between the user and the display unit can not be obtained since the sensing apparatus is not used and the user experience can not be adjusted correctly, and further realizes a technical effect that the user experience can be sensed and be adjusted properly.

### BRIEF DESCRIPTION OF THE DRAWINGS

FIG. 1 is a flow diagram of a method for adjusting a display unit according to an embodiments of the disclosure;

FIG. 2 is a plot showing the variation of the display brightness of the display screen with the viewing angle of the user according to the embodiments of the disclosure; and

FIG. 3 is a module diagram of an electronic device according to an embodiment of the disclosure.

### DETAILED DESCRIPTION

The embodiments of the disclosure provides a method for adjusting a display unit, so as to solve a technical problem in the prior art that a brightness of the display unit in the electronic device can not vary with a viewing angle of a user, and further realize a technical effect that a display brightness can be adjusted automatically by the electronic device when the viewing angle is changed.

The technical solutions according to the embodiments of the disclosure solve the technical problem that a brightness of the display unit in the electronic device can not vary with a viewing angle of a user in the following general idea.

Originally, the electronic device is at a display brightness when displaying an image by the display unit. In the prior art, the display brightness is constant. However, when the displayed image is viewed by the user from different angles, for example, the displayed image is viewed in a case that the sight of the user is at a 45-degree angle with the display unit, the display brightness felt by the user is weaker than the case where the sight of the user is at a 90-degree angle with the display unit. Therefore, in the embodiments of the disclosure, the information of the viewing angle of the user may be obtained by the electronic device, a brightness corresponding to the viewing angle may be obtained according to a viewing angle-to-brightness correspondence, and then a display effect suitable for the user under the viewing angle may be present to the user by adjusting the brightness, thereby realizing a technical effect that the display unit can display in the optimum brightness.

For purpose of better understanding, the technical solution described above will be explained in detail below in conjunction with drawings and the embodiments.

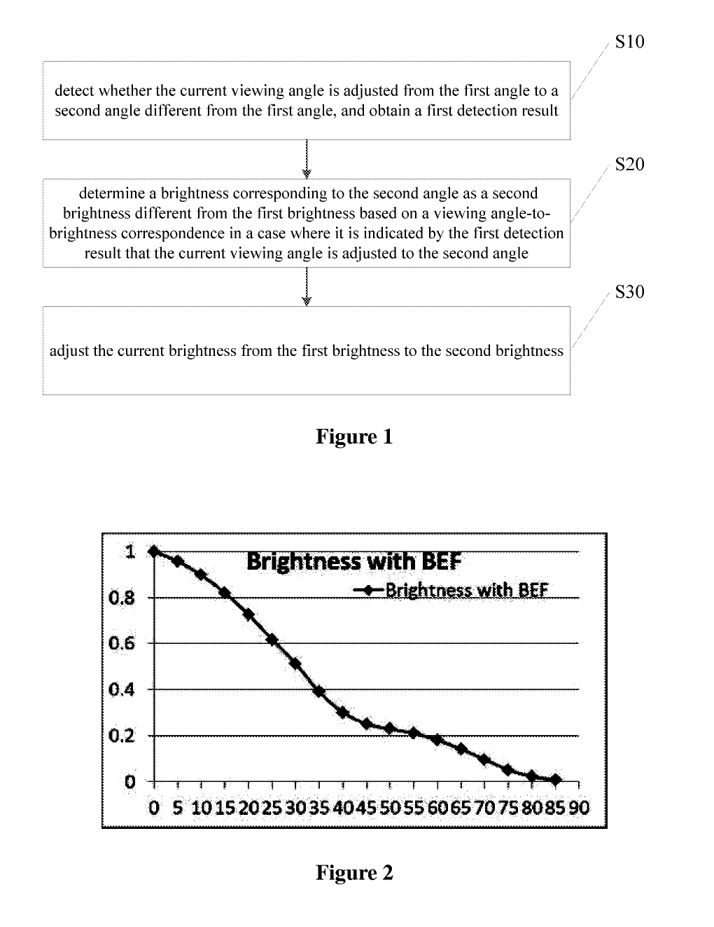

The embodiments of the disclosure provide a method for adjusting a display unit, where the method is applied to an electronic device having the display unit, and in a case where a current viewing angle at which a user views the display unit is a first angle, a current brightness of the display unit is a first brightness. As shown in FIG. 1, the method includes:

S10, detecting whether the current viewing angle is adjusted from the first angle to a second angle different from the first angle, and obtaining a first detection result;

S20, determining a brightness corresponding to the second angle as a second brightness different from the first brightness based on a viewing angle-to-brightness correspondence in a case where it is indicated by the first detection result that the current viewing angle is adjusted to the second angle; and

S30, adjusting the current brightness from the first brightness to the second brightness.

Specifically, in S10, before detecting whether the current viewing angle is adjusted from the first angle to a second angle different from the first angle, it is needed to obtain the value of the viewing angle at which the user views the display unit.

Steps for obtaining the viewing angle at which the user views the display unit are introduced below.

Step 1 is to detect first placement state information of the display unit.

In a specific implementation, the first placement state information may indicate a laid down placement state or a vertical placement state. Generally, the display unit of the conventional all-in-one PC or tabletop computer is in the vertical placement state, and a desktop tablet is in the laid down placement state. Of course, display unit of a portable tablet, a cell phone or the like may be in a placement state which is more flexible.

The first placement state information of the display unit can be detected by a gravity sensing apparatus provided in the electronic device. Alternatively, an angle between the display unit and a horizontal direction (that is, the placement state information) can be obtained by a gyroscope provided in the electronic device.

Step 2 is to obtain first relative position information for the user and the display unit based on the first placement state information.

In a specific implementation, in a case where it is detected that the display unit of the all-in-one PC is in a vertical placement state, it is detected that a relative position relationship between the user and the display unit is a face-to-face relationship due to the vertical placement state, that is, an angle between the user's line of sight and a plane of the display unit is approximately 90 degrees. In a case where it is detected that the desktop tablet is in a laid down placement state and a relative position relationship between the user and the display unit is that the user faces the display unit obliquely, an angle between the user's line of sight and a plane of the display unit is approximately 45 degrees.

The step further includes: capturing first position information of the user by an image capturing apparatus provided above the display unit; and obtaining the first relative position information for the user and the display unit based on the first placement state information and the first position information.

In a specific implementation, the first position information of the user is obtained by the image capturing apparatus provided above the display unit. It can be obtained from image information obtained by the image capturing apparatus whether the user faces the display unit squarely or faces the display unit obliquely.

Step 3 is to obtain the current viewing angle at which the user views the display unit based on the first relative position information. Step 3 may include: detecting whether the first relative position information is in conformity with a first preset relative position, and obtaining a second detection result; and determining a first viewing angle corresponding to the first preset relative position as the current viewing angle based on a preset relative position-to-viewing angle correspondence in a case where it is indicated by the second detection result that the first relative position information is in conformity with the first preset relative position.

The relative position relationship between the user and the display unit is obtained from the placement state of the display unit described above, so as to obtain the viewing angle at which the user views the display unit. For example, in a case where an angle between the user's line of sight and the display unit is 90 degrees, the current viewing angle is 0 degree, and in a case where an angle between the user's line of sight and the display unit is 45 degrees, the current viewing angle is 45 degrees. That is, the viewing angle at which the user views the display unit is an angle between the user's line of sight and a direction perpendicular to the display unit.

After the viewing angle at which the user views the display unit is obtained, the step 10 is performed in which it is detected whether the current viewing angle is adjusted from the first angle to a second angle different from the first angle, so as to obtain a first detection result.

In a specific implementation, after the first angle is obtained at a first moment, a second angle is obtained at a second moment. Specifically, the first detection result is obtained in a case where the second angle is different from the first angle. For example, the first angle obtained at the first moment is 0 degree, and the second angle obtained at the second moment is 45 degrees, where the term angle used here refers to the viewing angle, therefore, a detection result is obtained, which indicates that the current viewing angle is adjusted to the second angle. If the second angle is the same as the first angle, the detection of the viewing angle at which the user views the display unit is continued, until the viewing angle at which the user views the display unit is changed.

After S10, a brightness matched with the second angle is figured out according to the obtained second angle different from the first angle.

In a specific implementation, for example, it is detected by the electronic device at the first moment that the first angle of the viewing angle at which the user views the display unit is 0 degree, and it is detected by the electronic device at the second moment the second angle of the viewing angle at which the user views the display unit is 45 degrees. In a case where the first angle is 0 degree, a brightness of the display unit is 200 cd/m² (candle per square meter) according to a viewing angle-to-brightness correspondence. In the case that there is no viewing angle-to-brightness correspondence, the brightness of the display unit is also 200 cd/m² when the second angle is 45 degrees. However, since the viewing angle at which the user views the display unit is changed, a display brightness of the display unit obtained by the user at the viewing angle can not achieve a display effect same as the brightness of 200 cd/m², but only achieve a display effect as a brightness of 100 cd/m². FIG. 2 is a plot showing the variation of the display brightness of the display screen with the viewing angle of the user. It can be seen from FIG. 2 that the brightness of the display unit felt by the user changes as the viewing angle of the user gradually increases.

Therefore, it can be know from FIG. 2 that, for the purpose that the user at the 45-degree viewing angle can obtain a same effect as if the user views at the 0-degree viewing angle under a brightness of 1, it is required to compensate for a brightness of 0.25 at the viewing angle of 45 degrees. Since the brightness at this moment is one-fourth of that under the 0-degree viewing angle, it is required to quadruple the brightness at this moment, so that the user viewing the display unit at a 45-degree viewing angle can obtain a display effect in the term of brightness as if the user views the display unit at the 0-degree viewing angle.

The determining a brightness corresponding to the second angle as a second brightness different from the first brightness based on a viewing angle-to-brightness correspondence in a case where the current viewing angle of the user is changed from the first angle to the second angle includes:

deciding, in a case where it is indicated by the first detection result that the current viewing angle is adjusted to the second angle, whether the second angle is greater than the first angle, and obtaining a first decision result;

determining the brightness corresponding to the second angle as the second brightness greater than the first brightness based on the viewing angle-to-brightness correspondence in a case where it is indicated by the first decision result that the second angle is greater than the first angle; or

determining the brightness corresponding to the second angle as a second brightness smaller than the first brightness based on the viewing angle-to-brightness correspondence in a case where it is indicated by the first decision result that the second angle is smaller than the first angle.

In the embodiments of the disclosure, the first brightness corresponding to the first angle is a brightness conforming to a viewing effect for the user. If it is detected that the viewing angle of the user is changed from the first angle to the second angle and it is decided that the second angle is smaller than the first angle, then the second brightness corresponding to the second angle should be smaller than the first brightness corresponding to the first angle. It is assumed that the sight of the user is at a 45-degree angle with the display unit at a first moment, for example, the sight of the user is at a 45-degree angle with the display unit in the case that the display unit of the electronic device is in a laid down state and the user views the display unit in an upright state. At a second moment, the display unit of the electronic device is erected, and the user still views in an upright state, the angle between the sight and the display unit is 0 degree. Accordingly, in order to make the brightness of the display unit felt by the user at the first moment equal to that at the second moment, assuming that the brightness of the display unit at the first moment is 200 cd/m², then the brightness of the display unit at the second moment is 100 cd/m². Similarly, in a case where the display unit of the electronic device at the second moment is also in a laid down state, but a height at which the user views the display unit is lowered, the angle between the user's line of sight and the display unit is increased, and the display brightness of the electronic device at the second moment should be greater than 200 cd/m².

In the end, it is required to adjust the first brightness according to the analysis result described above, that is, to adjust the current brightness from the first brightness to the second brightness by: adjusting the first brightness to a second brightness greater than the first brightness in a case where the brightness corresponding to the second angle is the second brightness greater than the first brightness; or adjusting the first brightness to a second brightness smaller than the first brightness in a case where the brightness corresponding to the second angle is the second brightness smaller than the first brightness.

That is, when the viewing angle is increased, the display brightness of the display unit in the electronic device is adjusted to be brighter, and when the viewing angle is reduced, the display brightness of the display unit in the electronic device is adjusted to be weaker, so that an optimum effect of the visual brightness for the user can be satisfied while the display unit is viewed by the user from different viewing angle.

Based on the same inventive concept, another embodiment of the disclosure provides an electronic device in which the method for adjusting the display unit according to the disclosure may be implemented. The electronic device may be a notebook computer, a tablet computer, a cell phone and so on, and is not limited in the disclosure.

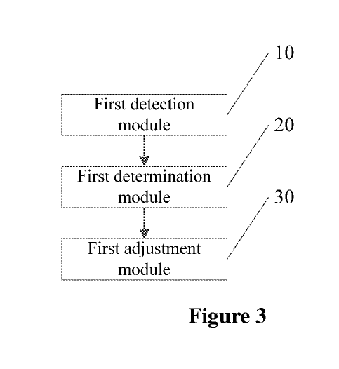

The embodiment of the disclosure provides an electronic device including a display unit. As shown in FIG. 3, the electronic device further includes: a first detection module 10 configured to detect whether a current viewing angle is adjusted from a first angle to a second angle different from the first angle, and obtain a first detection result; a first determination module 20 configured to determine a brightness corresponding to the second angle as a second brightness different from the first brightness based on a viewing angle-to-brightness correspondence in a case where it is indicated by the first detection result that the current viewing angle is adjusted to the second angle; and a first adjustment module 30 configured to adjust the current brightness from the first brightness to the second brightness.

Furthermore, the electronic device further includes: a second detection module configured to detect first placement state information of the display unit; a first obtaining module configured to obtain first relative position information for the user and the display unit based on the first placement state information; and a second obtaining module configured to obtain the current viewing angle at which the user views the display unit based on the first relative position information.

Furthermore, the second detection module is a gravity sensing apparatus.

Furthermore, the first obtaining module includes: a capturing unit configured to capture first position information of the user by an image capturing apparatus provided above the display unit; and a first obtaining subunit configured to obtain first relative position information for the user and the display unit based on the first placement state information and the first position information.

Furthermore, the second obtaining module includes: a first detection subunit configured to detect whether the first relative position information is in conformity with a first preset relative position, and obtain a second detection result; and a first determination subunit configured to determine a first viewing angle corresponding to the first preset relative position as the current viewing angle based on a preset relative position-to-viewing angle correspondence in a case where it is indicated by the second detection result that the first relative position information is in conformity with the first preset relative position.

Furthermore, the first determination module 20 includes: a first decision unit configured to decide, in a case where it is indicated by the first detection result that the current viewing angle is adjusted to the second angle, whether the second angle is greater than the first angle and obtain a first decision result; a second determination subunit configured to determine the brightness corresponding to the second angle as the second brightness greater than the first brightness based on a viewing angle-to-brightness correspondence in a case where it is indicated by the first decision result that the second angle is greater than the first angle; and a third determination subunit configured to determine the brightness corresponding to the second angle as the second brightness smaller than the first brightness based on a viewing angle-to-brightness correspondence in a case where it is indicated by the first decision result that the second angle is smaller than the first angle.

Furthermore, the first adjustment module 30 includes: a first adjustment subunit configured to adjust the first brightness to a second brightness greater than the first brightness in a case where the brightness corresponding to the second angle is the second brightness greater than the first brightness; and a second adjustment subunit configured to adjust the first brightness to a second brightness smaller than the first brightness in a case where the brightness corresponding to the second angle is the second brightness smaller than the first brightness.

There are at least the following technical effects or advantages in one or more technical solutions provided by the embodiments of the disclosure.

1. A change in a viewing angle at which the user views the display unit is obtained automatically by the electronic device, and a brightness corresponding to the current viewing angle is obtained according to a viewing angle-to-brightness correspondence, hence the brightness is adjusted to achieve an optimum display brightness, which effectively solves a technical problem in the prior art that the brightness of the display unit of the electronic device can not vary with a viewing angle of a user, and further realizes a technical effect that a display brightness can be adjusted automatically by the electronic device in a case where the viewing angle is changed.

2. The first placement state information of the display unit is detected by the gravity sensing apparatus, and the first position information of the user is captured by the image capturing apparatus, and then the first relative position information for the user and the display unit is then obtained based on the obtained first placement state information and the first position information, which solves the technical problems in the prior art that the information of a relative position between the user and the display unit can not be obtained since the sensing apparatus is not used and then user experience can not be adjusted correctly, and further realizes a technical effect that the user experience can be sensed and be adjusted properly.

It should be understood by those skilled in the art that, the embodiments according to the present disclosure may be implemented as a method, system or computer program product. Hence, the embodiments of the invention may be implemented with hardware only, with software only, or with a combination of hardware and software. Furthermore, the embodiments of the present disclosure may be implemented in computer program products in the form of computer readable media (including but not limited to magnetic disk storages, CD-ROM, optical storages, etc.) storing computer executable codes.

The description in this disclosure is made in conjunction with flowchart(s) and/or block diagram(s) of the method, device (system) or computer program product according to the embodiments of the disclosure. It should be understood that each process in the flowchart and/or each block in the block diagram and any combination of processes and/or blocks in the flowchart and/or the block diagram may be implemented through computer program instructions. The computer instructions may be provided to a processor of a general-purpose computer, dedicated computer, embedded processing machine or any other programmable data processing device to achieve a machine, in which device(s) to implement functions specified in one or more processes of the flowchart and/or one or more blocks of the block diagram is(are) achieved through executing the instructions by the computer or any other programmable data processing device.

The computer program instructions may further be stored in a computer readable storage which may lead the computer or any other programmable data processing device to operation in particular manner in order that a product including an instruction device is generated according to the instructions stored in the computer readable storage, where the instruction device is configured to implement the functions specified in one or more processes of the flowchart and/or one or more blocks of the block diagram.

The computer program instructions may further be loaded to the computer or any other programmable data processing device in order that a series of steps are executed on the computer or any other programmable data processing device to generate processes implemented by the computer, and the steps to implement the functions specified in one or more processes of the flowchart and/or one or more blocks of the block diagram are provided by the instructions executed on the computer or any other programmable data processing device.

Although the preferred embodiments of the disclosure have been described, additional alternations and changes may be made to the embodiments by those skilled in the art once acquiring the basic creative concept. Therefore, the appended claims are intended to cover the preferred embodiments and any alternations and changes falling within the scope of the disclosure.

Obviously, various changes and modifications can be performed on the disclosure by those skilled in the art without departing from the spirit and scope of the disclosure. The disclosure intends to cover those changes and modifications within the scope of the claims of the invention and equivalents thereof.

1. A method for adjusting a display unit, applied to an electronic device having the display unit, wherein in a case where a current viewing angle at which a user views the display unit is a first angle, a current brightness of the display unit is a first brightness, the method comprises:
detecting whether the current viewing angle is adjusted from the first angle to a second angle different from the first angle, and obtaining a first detection result;
determining a brightness corresponding to the second angle as a second brightness different from the first brightness based on a viewing angle-to-brightness correspondence in a case where it is indicated by the first detection result that the current viewing angle is adjusted to the second angle; and
adjusting the current brightness from the first brightness to the second brightness.

2. The method according to claim 1, wherein before the detecting whether the current viewing angle is adjusted from the first angle to a second angle different from the first angle, the method further comprises:
detecting first placement state information of the display unit;
obtaining first relative position information for the user and the display unit based on the first placement state information; and
obtaining the current viewing angle at which the user views the display unit based on the first relative position information.

3. The method according to claim 2, wherein detecting first placement state information of the display unit comprises:
detecting the first placement state information of the display unit by a gravity sensing apparatus in the electronic device.

4. The method according to claim 2, wherein obtaining first relative position information for the user and the display unit based on the first placement state information comprises:
capturing first position information of the user by an image capturing apparatus provided above the display unit; and
obtaining first relative position information for the user and the display unit based on the first placement state information and the first position information.

5. The method according to claim 2, wherein obtaining the current viewing angle at which the user views the display unit based on the first relative position information comprises:
detecting whether the first relative position information is in conformity with a first preset relative position, and obtaining a second detection result; and
determining a first viewing angle corresponding to the first preset relative position as the current viewing angle based on a preset relative position-to-viewing angle correspondence in a case where it is indicated by the second detection result that the first relative position information is in conformity with the first preset relative position.

6. The method according to claim 1, wherein determining a brightness corresponding to the second angle as a second brightness different from the first brightness based on a viewing angle-to-brightness correspondence in a case where it is indicated by the first detection result that the current viewing angle is adjusted to the second angle comprises:
deciding, in a case where it is indicated by the first detection result that the current viewing angle is adjusted to the second angle, whether the second angle is greater than the first angle and obtaining a first decision result;
determining the brightness corresponding to the second angle as the second brightness greater than the first brightness based on the viewing angle-to-brightness correspondence in a case where it is indicated by the first decision result that the second angle is greater than the first angle; or
determining the brightness corresponding to the second angle as the second brightness smaller than the first brightness based on the viewing angle-to-brightness correspondence in a case where it is indicated by the first decision result that the second angle is smaller than the first angle.

7. The method according to claim 6, wherein adjusting the current brightness from the first brightness to the second brightness comprises:
adjusting the current brightness from the first brightness to the second brightness greater than the first brightness in a case where the brightness corresponding to the second angle is the second brightness greater than the first brightness; or
adjusting the current brightness from the first brightness to the second brightness smaller than the first brightness in a case where the brightness corresponding to the second angle is the second brightness smaller than the first brightness.

8. An electronic device comprising:
a display unit;
a first detection module configured to detect whether a current viewing angle is adjusted from a first angle to a second angle different from the first angle, and obtain a first detection result;
a first determination module configured to determine a brightness corresponding to the second angle as a second brightness different from the first brightness based on a viewing angle-to-brightness correspondence in a case where it is indicated by the first detection result that the current viewing angle is adjusted to the second angle; and
a first adjustment module configured to adjust the current brightness from the first brightness to the second brightness.

9. The electronic device according to claim 8, further comprising:
a second detection module configured to detect first placement state information of the display unit;
a first obtaining module configured to obtain first relative position information for a user and the display unit based on the first placement state information; and
a second obtaining module configured to obtain the current viewing angle at which the user views the display unit based on the first relative position information.

10. The electronic device according to claim 9, wherein the second detection module is a gravity sensing apparatus.

11. The electronic device according to claim 9, wherein the first obtaining module comprises:
a capturing unit configured to capture first position information of the user by an image capturing apparatus provided above the display unit; and
a first obtaining subunit configured to obtain first relative position information for the user and the display unit based on the first placement state information and the first position information.

12. The electronic device according to claim 9, wherein the second obtaining module comprises:
a first detection subunit configured to detect whether the first relative position information is in conformity with a first preset relative position, and obtain a second detection result; and
a first determination subunit configured to determine a first viewing angle corresponding to the first preset relative position as the current viewing angle based on a preset relative position-to-viewing angle correspondence in a case where it is indicated by the second detection result that the first relative position information is in conformity with the first preset relative position.

13. The electronic device according to claim 8, wherein the first determination module comprises:
a first decision unit configured to decide, in a case where it is indicated by the first detection result that the current viewing angle is adjusted to the second angle, whether the second angle is greater than the first angle and obtain a first decision result;
a second determination subunit configured to determine the brightness corresponding to the second angle as the second brightness greater than the first brightness based on the viewing angle-to-brightness correspondence in a case where it is indicated by the first decision result that the second angle is greater than the first angle; and
a third determination subunit configured to determine the brightness corresponding to the second angle as the second brightness smaller than the first brightness based on the viewing angle-to-brightness correspondence in a case where it is indicated by the first decision result that the second angle is smaller than the first angle.

14. The electronic device according to claim 8, wherein the first adjustment module comprises:
a first adjustment subunit configured to adjust the current brightness from the first brightness to the second brightness smaller than the first brightness in a case where the brightness corresponding to the second angle is the second brightness smaller than the first brightness; and
a second adjustment subunit configured to adjust the current brightness from the first brightness to the second brightness greater than the first brightness in a case where the brightness corresponding to the second angle is the second brightness greater than the first brightness.
